(19) United States
(12) Patent Application Publication
(10) Pub. No.: US 2021/0052049 A1
(43) Pub. Date: Feb. 25, 2021

(54) AUTOMATED GUIDED VEHICLE NAVIGATION AND PROTECTION SYSTEM

(71) Applicant: LINGDONG TECHNOLOGY (BEIJING) CO. LTD, Beijing (CN)

(72) Inventor: Botao ZHENG, Beijing (CN)

(21) Appl. No.: 16/079,030

(22) PCT Filed: Aug. 8, 2018
(86) PCT No.: PCT/CN2018/099320

§ 371 Date: Aug. 22, 2018

(51) Int. Cl. A45C 5/14; G05D 1/02; A45C 5/03; A45C 13/26; A45C 13/36; A45C 15/00; F16F 1/36

(52) U.S. Cl. CPC A45C 5/14; G05D 1/0231; G05D 1/0255; G05D 1/0227; F16F 1/36; A45C 5/03; A45C 13/262; A45C 13/36; A45C 15/00; G05D 1/0214

(57) ABSTRACT

A luggage protection system including a luggage body. The luggage body has a bottom side, a front face, a handle face, at least one lateral face sharing an edge with each of the bottom side, the front face, and the handle face. The luggage protection system further includes a ground detection unit attached to the luggage body. The ground detection unit is configured to determine whether the ground adjacent to the luggage body is substantially level. The luggage protection system further includes a drive system configured to propel the luggage body. The luggage protection system further includes a communication system, wherein the communication system is configured to transmit a warning signal in response to the around detection unit determining the ground adjacent to the luggage body is not substantially level.

### BACKGROUND

Automated guided vehicles (AGVs) include robotic or self-propelled devices such as smart luggage. Smart luggage is an increasingly common product in the travel industry because users are provided with convenient and affordable methods of conveying items without the user needing to manually carry or propel the items. Automated guided vehicles include electronic components that are prone to damage associated with impact when vehicle bodies tip and/or fall. Automated guided vehicle bodies include rigid components that transmit shock associated with impact of the rigid components against the ground or other hard surfaces. Transmitted shock disrupts electrical connections within automated guided vehicle control systems to reduce functionality or increase malfunctions of the automated guided vehicles. Damaged luggage components are expensive and time consuming to replace.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of a automated guided vehicle, in accordance with some embodiments.

FIG. 2 is a schematic diagram of a ground detection unit for a automated guided vehicle, in accordance with some embodiments.

FIG. 3A is a diagram of a automated guided vehicle detecting a ground surface, according to some embodiments.

FIG. 3B is a diagram of a automated guided vehicle detecting a change in around elevation, according to some embodiments.

FIG. 4 is a schematic diagram of a automated guided vehicle circuit, according to some embodiments.

FIG. 5 is a flow diagram of a method of operating a automated guided vehicle, according to some embodiments.

FIGS. 6A-6B are diagrams of an automated guided vehicle striking an obstacle, according to some embodiments.

FIG. 7A-7B are exploded views of a shock-protection module integral to a handle in a automated guided vehicle, according to some embodiments.

FIGS. 8A-B are diagrams of shock-protection modules integral to a luggage body, according to some embodiments.

FIGS. 9A-B are diagrams of shock-protection modules integral to a body of a automated guided vehicle, according to some embodiments.

### DETAILED DESCRIPTION

The following disclosure provides many different embodiments, or examples, for implementing different features of the provided subject matter. Specific examples of components, values, operations, materials, arrangements, etc., are described below to simplify the present disclosure. These are, of course, merely examples and are not intended to be limiting. Other components, values, operations, materials, arrangements, etc., are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another elements) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Recent developments in interconnected devices has led to the development of automated guided vehicles (AGVs, or “smart” luggage) capable of interacting with a user without the user's direct manual manipulation. AGVs and other interactive devices such as smart luggage are capable of transmitting signals to users when the devices exceed a prescribed distance from a location, a user, or a device retained by the user. AGVs are capable of maintaining a prescribed distance from a user, or a device retained by the user, while the user moves between locations, such as between gates at an airport. At least one embodiment of the present disclosure discusses one form of AGV, “smart” luggage, although other forms of AGV or interactive devices are also envisioned within the scope of the disclosure. Hereinafter, the terms “smart luggage” or “luggage system” are used for convenience, but without limitation on the broader range of AGVs that are envisioned by the present application.

Smart luggage contains electrical components that are configured to perform position sensing operations, proximity sensing operations, security operations, and user identification operations. Smart luggage includes, in some embodiments, batteries or other power storage systems, computerized systems for generating, receiving, and interpreting signals generated at and received by system sensors, electronic systems capable of propelling, using a drive system, the luggage across a ground or driving surface, among other systems. The electrical components of the smart luggage, or luggage system, are prone to damage when luggage, or the components therein, experience rapid vibrations, blows, or shocks. Rapid vibrations, blows, or shocks can occur in luggage systems when the luggage system tips over or falls down. When a rigid portion of the luggage system body, or luggage body, impacts a hard surface (a floor, or the ground), the impact triggers vibrations that travel through the luggage body and vibrate electrical components in the luggage system and attached to the luggage body. Vibrations traveling through the luggage body can break components and/or shake electrical components apart, reducing luggage system operability or making the luggage system, or subsystems, inoperable. A luggage system with components that detect and avoid conditions where the luggage system is as risk of falling, or a luggage system that has mechanisms that absorb vibrational energy (shock, impact, and so forth) is desirable to extend luggage system operable life, and to reduce a likelihood of luggage system damage (and repair costs) when a luggage system falls or strikes a floor or ground.

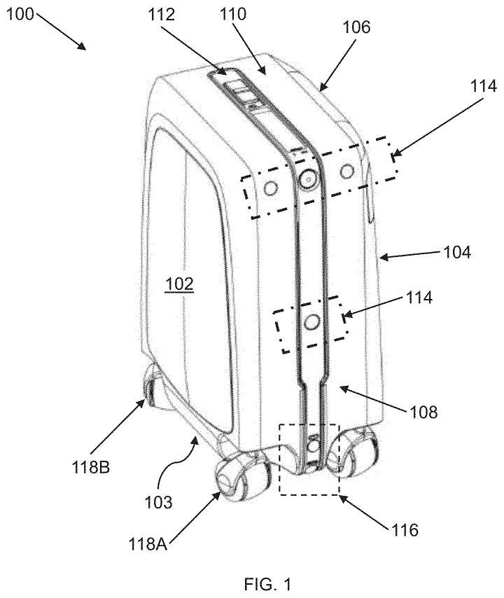

FIG. 1 is a diagram of a automated guided vehicle 100, in accordance with some embodiments. AGV 100 includes a luggage body 101 with a front face 102, a bottom side 103, a handle face 104 (or, a back side, the side at which a handle is fastened in handled luggage systems, the side closest to the user when pulling the luggage), an optional handle 106, at least one lateral face 108, and a top side 110. Electrical components 112, 114, and 116 are located on or extend through external surfaces of luggage body 101. In some embodiments, electrical component 112 is a user interface for interacting with other electrical components of the luggage system. In some embodiments, electrical components 114 are visual systems used for guiding and/or interacting with (e.g., unlocking) the automated guided vehicle 100. In some embodiments, the electrical components 114 include proximity sensors such as ultrasonic, infrared, optical, RF, and/or other sensors used to detect a position of a user with respect to the position of the automated guided vehicle 100. In some embodiments, luggage system 110 includes a ground detection unit 116 configured to monitor a detection region in front of (with respect to a direction of travel of the luggage system). Ground detection unit 116 is configured to receive a ground presence signal, indicating that the level of the around, or the rolling surface in front of the luggage system, is at a same height as the ground below the luggage system, or accessible to the luggage system by rolling. Ground detection unit 116 is configured to detect abrupt changes in around elevation, including changes both upward and downward. By detecting abrupt changes in ground elevation, a luggage system ground detection unit helps to prevent automated guided vehicle 100 from impacting a step elevation or from falling after a luggage system moves partially or completely over a step edge. An automated guided vehicle 100 has wheels. Some wheels of the luggage system are passive wheels 118A. Passive wheels 118A are not connected to or part of a drive system in the luggage system. Some wheels of the luggage system are drive wheels 118B, part of a drive system in the luggage system. In some embodiments, all wheels of automated guided vehicle 100 are drive wheels 118B.

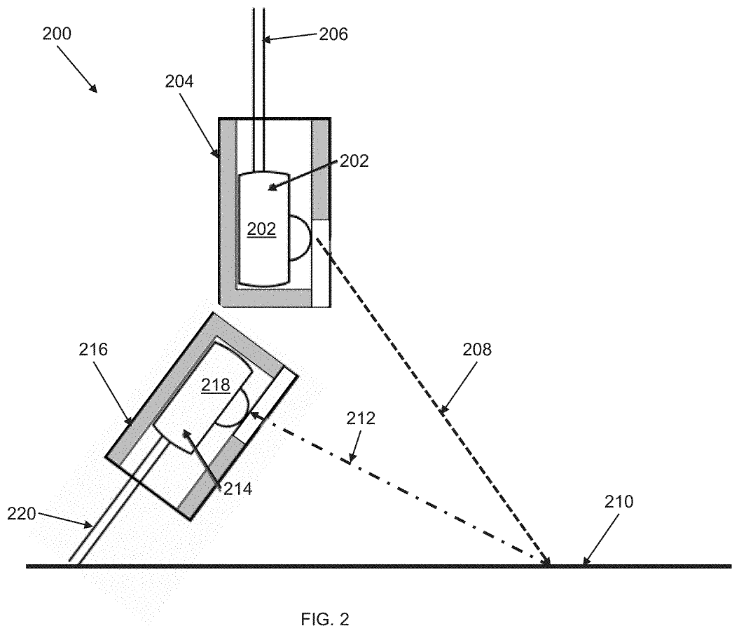

FIG. 2 is a schematic diagram of a ground detection unit 200 for an automated guided vehicle (AGV), in accordance with some embodiments. Ground detection unit 200 has a signal emitter 202 and a signal receiver 218. Signal emitter 202 is in a signal emitter housing 204 and connected to the AGV via a connection 206. Signal emitter 202 emits a transmitted ground signal 208 and signal receiver 218 receives a ground presence signal 212. Ground presence signal 212 is the transmitted ground signal 208 after reflection from a surface 210. Surface 210 is the ground, or a rolling surface on which the AGV travels. Signal receiver 218 is located in a receiver housing 216 and has a signal transceiver 214 that processes ground presence signal 212 and communicates the ground presence signal 212 to the AGV via connection 220.

In some embodiments, ground detection units emit and receive ultrasonic signals. In some embodiments, ultrasonic signals are emitted in pulses and a timing between emission of a pulsed signal and receiving a received ultrasonic signal to calculate a distance between the AGV, luggage body, and/or ground detection unit, and the ground surface. In some embodiments, a continuous ultrasonic signal is emitted and undergoes frequency modulation. Timing of a particular frequency being received at the ground detection unit signal receiver correlates to a distance between the ground detection unit and the ground surface. In some embodiments, ground detection units emit and receive a non-visible light signal. In some embodiments, ground detection units emit and receive visible light signals. In sonic embodiments, ground detection units contain only mechanical-type signal receiver units. A mechanical-type signal receiver includes a transceiver configured to transmit a ground presence signal when the mechanical-type signal receiver is in physical contact with a ground surface, Other types of ground detection units, known in the art, are also envisioned within the scope of the present disclosure.

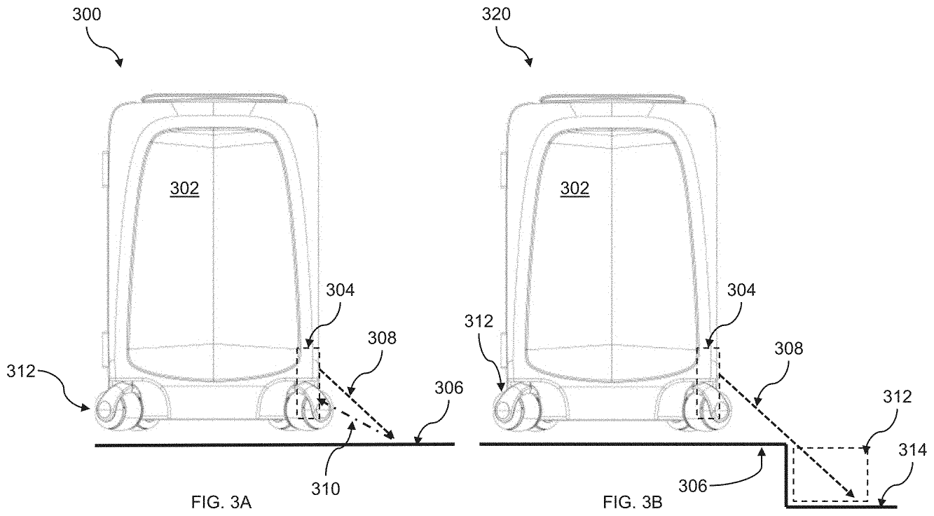

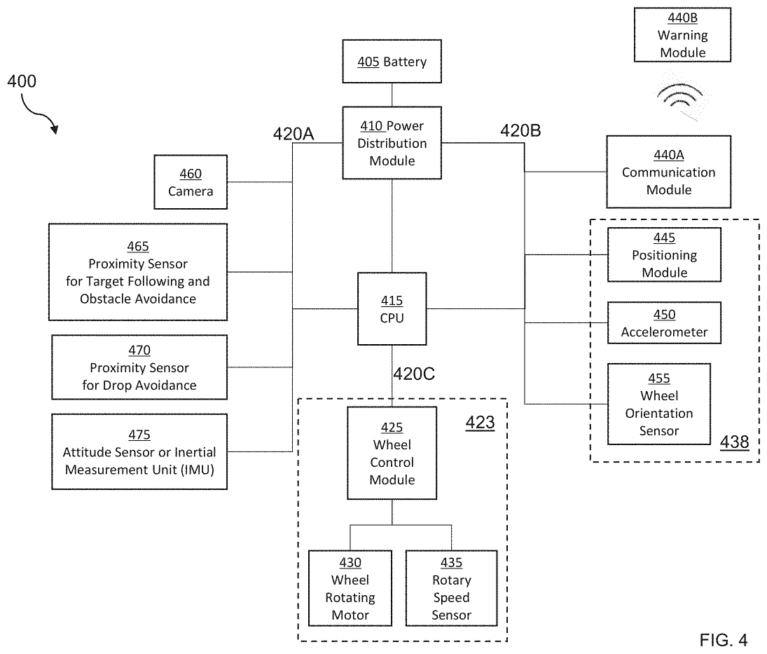

FIG. 3A is a diagram of an AGV 300 detecting a ground surface 306, according to some embodiments. AGV 300 has luggage body 302 with a ground detection unit 304 located therein. Ground detection unit 304 emits a transmitted ground detection signal 308, which is reflected off of the ground 306 in a detection region 314, and becomes a received signal at the ground detection unit, or ground presence signal 310. In some embodiments, while a ground presence signal 310 is received by the AGV 300, powered wheels 312 of the AGV drive the luggage body 302 forward toward the detected region 314 in front of the AGV.

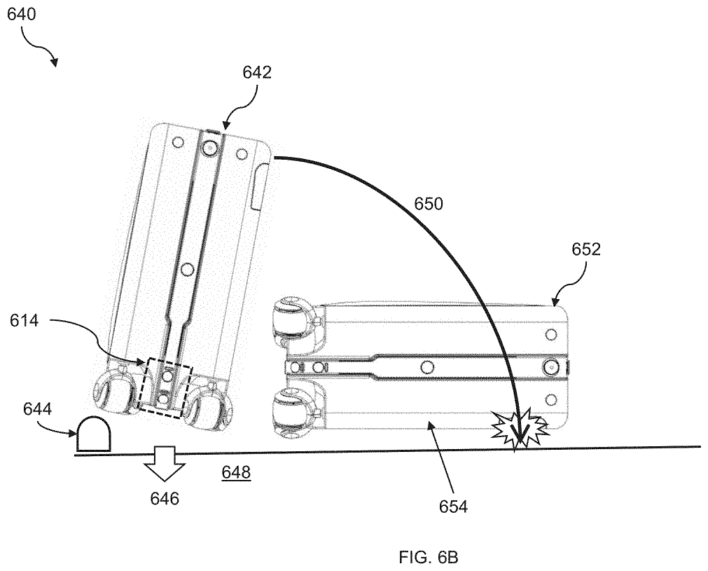

FIG. 3B is a diagram of an AGV 320 detecting a change in floor elevation, according to some embodiments. AGV 320 has a luggage body 302 with ground detection unit 304 configured to emit a transmitted ground detection signal 308. Transmitted ground detection signal 308 does not strike ground surface 306 because the ground elevation has changed. Transmitted around detection signal 308 extends through an open space 324 above a lowered ground surface 328 and strikes lowered ground surface 328 at an altered detection region 326. Absence of a ground presence signal detected by AGV 320 (or, by ground detection unit 304) causes a communication system in the AGV 320 to transmit a drive system warning signal to a drive system (also known as a drive control circuit, not shown) to modify the performance of wheels 312 that propel the AGV on around surface 306. In some embodiments, the drive system is configured to reduce a wheel rotation velocity in order to control a speed of AGV 320. In some embodiments, the drive system halts rotation of the wheels, bringing the AGV 320 to a halt in order to prevent AGV 320 from falling to a lowered ground surface. In the similar manner, a one side obstacle 644, also called an offset obstacle, shown in FIG. 6B detected by ground detection unit 614 causes a communication system in the AGV 642 to transmit a drive system warning signal to a drive system to modify the performance of wheels that propel the AGV on ground surface 648. Considering that one side obstacle or one side rising ground is very likely to cause luggage tipping, it is important to use different approaches to handle this situation from the situation of an obstacle or rising ground affecting both sides. In some embodiments, both side obstacle or rising ground situation can be handled by slowing down the speed of the AGV to pass over; on the other hand, one side obstacle or rising ground situation can be handled by steering the luggage system around the side of the offset obstacle to avoid striking the obstacle. In some embodiments, a luggage system determines to stop wheel motion to prevent striking the offset obstacle, rather than steering to go around the offset obstacle.

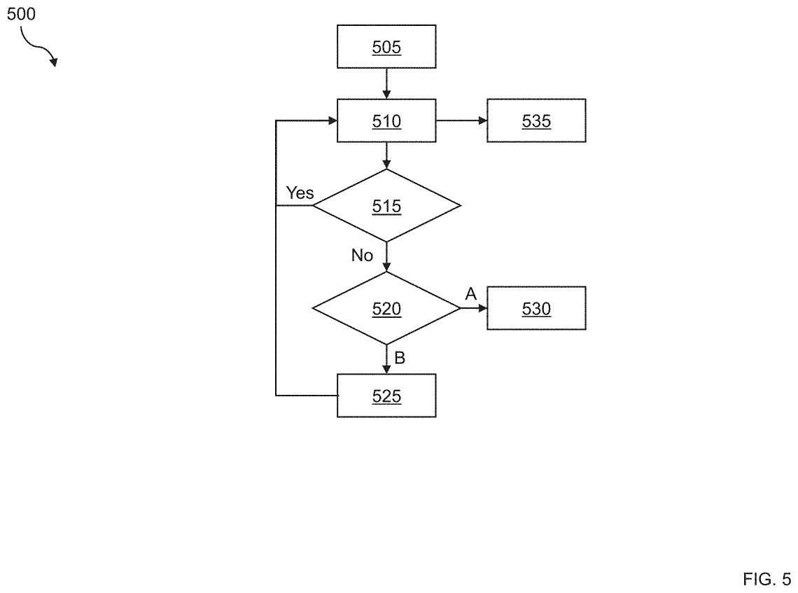

FIG. 4 is a schematic diagram of an AGV circuit 400, according to some embodiments. System circuit 400 includes a battery 405 electrically connected to a remainder of the system circuit by a power distribution module 410. Power distribution module 410 transmits power to other system circuit components over a power bus. Power bus and a communication bus are combined in FIG. 4 in system bus 420A-C, which combine power delivery and communication functions among AGV components. In some embodiments, system bus 420A-C are a single bus, such as a plurality of universal serial bus connections that distribute power and communication functions between system components. In sonic embodiments, system bus 420A-C is a set of paired busses, each performing a specific (e.g., power delivery or communication) function) for the system circuit.

Central processing unit (CPU) 415 is connected, via system bus 420C to a drive control circuit 423 (also known as a drive control system, or a drive system), by system bus 420A to a guidance module 438 and a communication module 440A, and by system bus 4209 to a system sensor module 458 containing system sensors including an attitude sensor/inertial measurement unit (IMU) 475, a ground detection unit or ground proximity sensor 470 (to avoid falls/drops), a proximity sensor 465 (for target following/obstacle avoidance), and a camera 460. In some embodiments, a number and type of sensors in system sensor module 458 differs from the configuration shown herein. In sonic embodiments, camera. 460 is a monocular camera. In some embodiments, camera 460 is a binocular, or stereo, camera. In sonic embodiments; proximity sensor 465 is a sonar sensor, an infrared (IR) sensor, a LiDAR sensor, a radar sensor, or some other sensor that allows non-contact measurement of distance between an AGV and obstacles around which the AGV attempts to navigate. Proximity sensor 470 (ground detection unit) is, in some embodiments, an ultrasonic sensor system, a laser sensor system, and/or a mechanical sensor system that is configured to detect and report the presence of a surface on which an AGV can roll to self-propel.

Proximity sensor 470 (a drop avoidance proximity sensor, or a ground detecting unit) is configured to detect a change in elevation of the surface on which the AGV is traveling. When proximity sensor 470 detects a change in elevation of the surface on which the AGV is traveling, either a downward change (a step down, or a downward traveling escalator) or an upward change (a step up, or an upward traveling escalator) proximity sensor 470 transmits a status change signal to the central processing unit 415 to indicate that the ground presence signal normally received by proximity sensor 470 is absent.

Proximity sensor 465, used for following a target or avoiding obstacles along a planned path of travel, includes, alternatively, of cameras, LiDAR systems, ultrasonic systems, or infrared systems used to identify an obstacle in front of a traveling AGV, or to identify a target object to which the AGV attempts to remain near. Attitude sensor 475 (also known as and inertial measurement unit, or MU) is a sensor within a luggage body intended to detect deviations from a normal attitude with respect to the surface on which the AGV travels. For example, an attitude change may include traveling on a smooth surface up a ramp along a direction of travel. Another example of an attitude change includes an AGV traveling beyond a stair edge and tilting such that the center of gravity of the AGV is no longer directly over the bottom surface of the luggage between the wheels. When the center of gravity is not directly over the wheels for the floor between the wheels, the AGV enters an uncontrolled tipping state and falls to strike the floor. Attitude sensor 475 includes, in some embodiments, one or more gyroscopes, one or more motion reference units, and/or electrical components configured to provide a tilting signal to the central processing unit when the AGV is no longer vertically oriented. In some embodiments, an AGV attitude sensor triggers a tilt warning signal to a user. In some embodiments, an AGV attitude sensor triggers the drive control circuit 423 to stop wheel motion to prevent the AGV from falling. In some embodiments, an AGV attitude sensor triggers the drive control circuit 423 to stop wheel motion after the luggage body has tipped over or fallen off for safety concerns. Attitude sensor 475 works in combination with central processing unit 415, wheel control module 425, and accelerometer 450 in order to recognize when a tilt condition exists and a tilt warning signal should he transmitted to a user.

Guidance module 438 includes a positioning module 445, an accelerometer 450, and a wheel orientation sensor 455. In some embodiments, guidance module 438 sends signals from the accelerometer and the wheel position sensor to the CPU 415. In some embodiments, positioning module 445 operates by one or more of a global navigating system circuit (Global Positioning Satellites [GPS], and so forth), wireless connection (e.g. WiFi) antenna triangulation, and/or other RF antenna triangulation systems, including Bluetooth™ antenna beacons. Drive control circuit 423 includes a wheel control module 425, a wheel rotating motor 430, and a wheel rotary speed sensor 435. In some embodiments, drive control circuit 423 receives instructions from CUP 415 based on signals received by the CPU from guidance module 438 in order to continue, or to modify, motion of the AGV. Wheels in an AGV are powered independently in order to allow steering and speed regulation of the AGV. Wheel control module 425 receives commands from a central processing unit 415 regarding a desired rate of speed and a desired orientation of the AGV with regard to an external reference point and directs the AGV toward a desired external reference point by adjusting individual wheel rotation speeds to cause the AGV to move forward, backward, or to pivot, based on a number of wheels supplied power, and the direction of rotation of each wheel when the wheel is driven by the drive control circuit 423. Wheel control module 425 works in conjunction with guidance module 438 to orient and power wheel motors, and to steer and propel the AGV during travel to a desired external reference point.

AGV circuit 400 includes a warning module 440B communicatively coupled to communication module 440A. Warning module 440B is configured to alert a user, via a sound, a vibration, or a flashing light, or some other method, of a change to the status of an AGV, including stalling, tipping, being lost (e.g., unable to determine a location, or unable to determine a path out of a location toward a target destination, and so forth). In some embodiments, warning module 440B is a wristband module wirelessly coupled to communication module 440A to receive warning signals from the communication module 440A indicating a status signal from one or more sensors, or control modules, of the system circuit. In some embodiments, warning module 440B is replaced and/or supplemented by a combination of a user-provided hardware module (e.g., a smart telephone) running a software application configured to communicatively couple the user-provided hardware module to the communication module 440A.

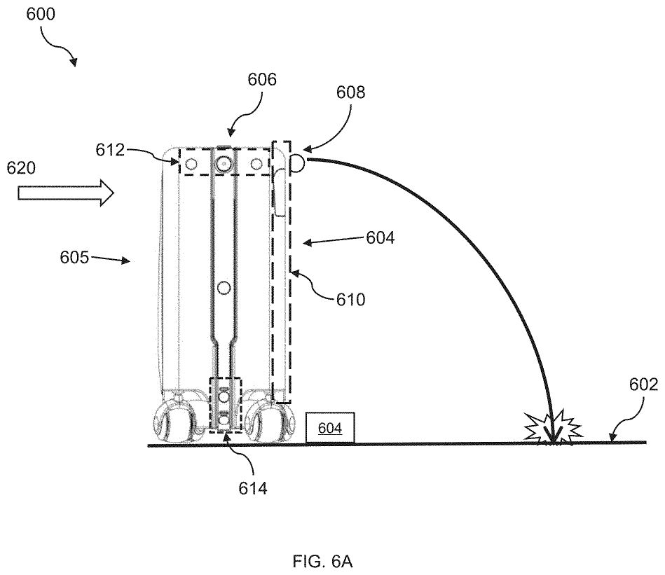

FIG. 5 is a flow diagram of a method 500 of operating an AGV, according to some embodiments. Method 500 includes an operation 505 in which an AGV detects a ground surface below and/or in front of the AGV to determine that it is safe to move the AGV without tipping or falling. Operation 505 includes coordination between proximity sensor 470, attitude sensor 475, and central processing unit 415 to [1] detect a ground presence signal received by ground detection unit (proximity sensor 470) indicates that the ground presence signal has been received to the central processing unit, [2] identify that the AGV is not tilted (with attitude sensor 475), and [3] transmit a signal to a drive control circuit in preparation for initiating wheel movement. Method 500 includes an operation 510, in which, upon receiving a signal to move the wheels at a drive control unit, the drive control unit initiates wheel rotation to move an AGV in a forward direction, either toward a target location, or to follow behind a user.

During luggage movement, central processing unit 415 (see FIG. 4 above) remains ready to stop will movement upon receiving a stop instruction from a sensor that identifies the location to which the AGV is moving, a user toward which the AGV is moving, or from an AGV control module held by one or more users of the AGV. In optional step 515, upon receiving a stop instruction during wheel movement, the drive control circuit in AGV turns off the wheel drivers (wheel motors, or brushless motors) to help forward motion or rotation of the AGV. Method 500 includes an operation 520 in which, during wheel movement initiated by operation 510, central processing unit 415 monitors a “run condition” of the AGV. The run condition of the system is positive or negative. A positive run condition exists when the ground in front of the AGV appears to be substantially level and smooth, and when the luggage is vertical, or when all wheels are on the ground. A negative run condition exists when the ground in front of the AGV is rough, stepped, or discontinuous, and/or when the luggage is tipped, with one or more wheels separated from the ground. In some embodiments, the ground is considered substantially level when there are no obstacles in a direction of travel along which the luggage is moving on the ground. In some embodiments, the luggage system evaluates the ground surface and reports a negative run condition when there is an obstacle directly in front of the luggage system wheels. In some embodiments, the luggage system evaluates the ground surface and reports a negative run condition when there is an obstacle in front of one, but not both, wheel at a front side of the luggage system with respect to a direction of travel of the luggage. In some embodiments, the luggage system In some embodiments, the ground is considered substantially level when the ground is flat, or has an incline that keeps the center of mass of the luggage system above the bottom of the luggage system, and between the wheels thereof. In some embodiments, the ground is not considered substantially level when the ground has an incline that, when the luggage transitions to the incline, or is on the incline, puts the center of mass of the luggage system over a point outside a bottom perimeter of the luggage system, or moves the center of mass directly over a bottom edge of the luggage. When the center of mass of the luggage system is not directly over the bottom of the luggage system, the luggage system is likely to fall.

The system sensor module uses proximity sensor 470 to differentiate between times when the ground below and in front of the AGV is level, smooth, and/or continuous, and times when the ground below and in front of the AGV is rough, stepped, and/or discontinuous. Proximity sensor 475 monitors the posture of the AGV. Posture relates to the vertical orientation of the AGV, with all wheels on the ground. When an AGV tips or overruns an edge of a rolling surface, proximity sensor 475 reports a rapid posture change (tipping, or falling) to the central processing unit 415. By detecting the ground surface condition, or the presence or absence of the ground present signal, and by monitoring the posture of the AGV, the system sensor module and the central processing unit maintain a positive run condition status for the AGV, and enable further forward motion. When a sensor in the system sensor module (see element 458, above) detects that the ground surface in front of the AGV is level, smooth, or smoothly sloping, the method continues by proceeding to operation 510 wherein wheel motion continues. When a sensor in the system sensor module text that ground surface in front of the luggage is stepped, or rough, or discontinuous, the method proceeds to operation 575.

In operation 525, the AGV determines a response action upon detection of a rough or step to service in front of the AGV. The method 500 optionally proceeds to operation 530, in which a warning signal is transmitted to a user, either in a user retained bracelet or other dedicated warning module, or to a user provided computing device running a software application that includes a set of software instructions configured to identify warning signal received by an antenna in the user provided computing device and, responsive to receiving the warning signal, presenting an alert signal to the user to indicate that the ground surface in front of the AGV does not appear to be smooth or smoothly sloping. The method then continues in one of operation 535 or operation 540 according to the content of a configuration file stored in the AGV. When the configuration file includes a halt instruction upon receiving notice that the ground presence signal has been interrupted, the method proceeds to operation 540, wherein the drive control circuit stops wheel rotation to prevent the AGV from traversing the detection region where the ground presence circuit was interrupted. When the configuration file includes a follow instruction upon receiving notice of the ground presence signal has been interrupted, the method proceeds to operation 535, wherein the drive control circuit continues to provide power to the drive wheels in a manner consistent with that triggered in operation 510. From operation 535, the method proceeds to operation 520, wherein sensors in the system sensor module continue to evaluate ground surface condition in the detection region in front of the AGV. The method continues by looping between operations 510 and 520, or by looping between operations 510 and 535, according to a condition of the ground surface in front of the AGV, or until a stop instruction is received by the system.

Subsequent to performance of operation 540, wherein wheel motion is stopped based on the absence or interruption of a ground presence signal and the presence, in a configuration file, of a stop instruction, the AGV remains in a quiescent state, waiting for a user instruction. The method proceeds to optional operation 545, wherein, a movement instruction is received by the AGV. Subsequent to operation 545, the method proceeds to operation 505.

During movement of the AGV across the ground, the CPU 415 determines, in operation 515, and based on a signal from the proximity sensor 470, whether the ground in front of the AGV is safe for continued movement. During operation of the drive control circuit 423, proximity sensor 470 operates, either continuously or periodically, to provide a ground presence signal. An interval between receiving a ground presence signal is configured to be sufficiently small that the AGV will not travel beyond a safe distance (e.g., the distance of the detection region in front of the AGV, verified safe by the proximity sensor 470) before a next measurement of the ground presence signal occurs. During operation of the drive control circuit 423, while the ground presence signal is detected, the method continues on to operation 510. During operation of the drive control circuit 423, when the around presence signal is absent, the operation continues on to operation 520.

In operation 520, the AGV determines a type of “ground presence absent” operation to perform based on a configuration file of the AGV stored in a communication module 440A, or some other module of the m circuit 400. Based on a first content of the configuration file, the method proceeds to an operation 530, wherein the central processing unit 415 directs the guidance module 438 and the drive control circuit 423 to halt motion of the AGV. Based on a second content of the configuration file, the method proceeds to an operation 525, wherein the central processing unit 415, based on an absence of the ground presence signal to the proximity sensor 470, and a system status update from the proximity sensor 470 to the CPU 415, directs the communication module 440A to transmit to the warning module 440B, a warning signal directing the warning module to alert the user that the AGV has [1] encountered a potential obstacle and [2] is continuing to self-propel [operation 510] despite the absence of the ground presence signal. In some embodiments, a user will desire to configure the AGV (with the second content of the configuration file) to continue movement despite the absence of the ground presence signal because the user has previously determined that the ground is appropriate for AGV motion. Thus, an AGV warning of no ground presence signal would indicate to the user that a sensor problem exists, or that the ground surface has altered properties (reflectance, albedo, cleanliness, and so forth) that have interfered with receiving the ground presence signal. In some embodiments, the user will desire to configure (with the first content of the configuration file) the AGV to halt upon any anomalous condition. In some embodiments, the user uses the warning module 440B, or a user interface on the luggage body to clear an anomalous condition alarm from the AGV circuit and to enable continued movement of the AGV across the ground. A warning, module has, in some embodiments, a user interface that allows a user to direct the AGV to reset an alarm condition. The warning module indicates the user reset command, via the communication module, to the central processing unit for processing.

FIG. 6A is a diagram of an AGV 600 striking an obstacle 604, according to some embodiments. A force 620 is applied to a top end of the AGV 600. Force 620 is applied laterally to the AGV. When the top end is moved by the force 620, and a wheel at the bottom end strikes an obstacle 604, the AGV tips to strike the ground 602. The AFV tips over the obstacle 604 to tip sideways and strike the ground 602. The top end 606 of the AGV strikes the ground 602 with greater force than the bottom of the AGV because of the greater velocity achieved by the top end before striking the ground. Generally an AGV has a “back” side or a handle side 604, where an extensible handle 608 is stored in the luggage body. Because of the rigid frame (not shown) around the extensible handle in a luggage body, electrical components are mounted to the rigid frame, or to connector elements fastened to the extensible handle frame to secure them within the luggage body and/or to protect them from damage (crushing, and so forth). A “front” or opening side 605 of AGV 600 generally has few or no electrical components. Thus, electrical components are generally located in a component region 610 on the handle side 604 of the luggage body that strikes the ground when a fall occurs. Shock transmitted through the luggage body to electrical components in the AGV, or direct torsion/vibration of electrical components, can cause an AGV to malfunction or fail. Electrical components 612 and 614 that extend through the luggage body on a lateral face, or on the handle side, are also subject to damage because of impact and/or shock.

FIG. 6B is a diagram 640 of an upright AGV 642 that strikes an obstacle 644 on the ground 648 while moving in a first direction 646. The force of striking the obstacle 644 causes the AGV to lift up on one side while moving in the first direction 646. When the upward motion is large enough for the center of mass of the AGV to move laterally past the wheels the AGV, the AGV falls and strikes the ground 648. The tipped AGV 652 strikes the ground with greater force at the top end because the fall path 650 is longer for the top of the AGV than for the bottom of the AGV. Thus, the components in the AGV located near the top strike the ground 648 with greater force than the components at the bottom of the AGV body, resulting in greater shock transmittal through the AGV body. Greater shock transmittal is associated with additional damage to the electrical components, and increases the likelihood of damage to said electrical components.

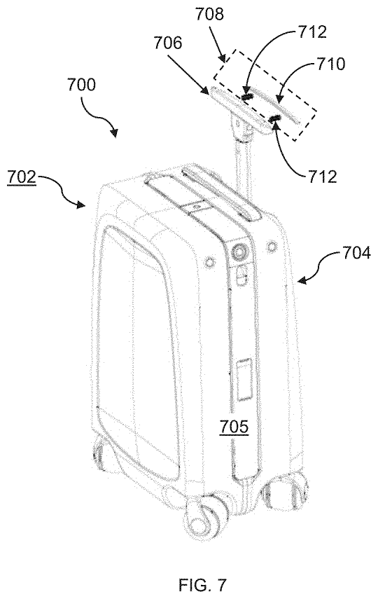

FIG. 7A is an exploded view of an AGV 700 with a shock-protection module 708 integral to a handle 706, according to sonic embodiments. AGV 700 has a luggage body 702 with a handle side 704. Handle 706 extends upward from handle side 704 when a user extends the handle to pull the luggage, or (in some embodiments) when the AGV is self-navigating. Handle 706 includes a handle grip 706A and handle arm 706B. In some embodiments, handle 706 includes more than one handle arm extending from the luggage body 702 and connected to the luggage handle 706A.

Luggage body 702 is more prone to fall toward handle side 704 than toward lateral face 705. Thus, the handle 706 is likely to receive a high-impact shock when the luggage body 702 falls and strikes the ground. Thus, a shock protection module 708 on luggage handle 706 protects the handle, electrical components (not shown) in the handle, and (indirectly) components in the luggage body 702, from impact-induced damage. Shock protection module 708 includes at least one energy absorbing unit 712 and an impact plate 710. In some embodiments, an impact plate is broad and flat. In some embodiments, an impact plate is elongated and narrow. An impact plate is a rigid material intended to strike a ground surface or other material while protecting the portion of the luggage body and/or handle to which the impact plate is fastened. In sonic embodiments, impact plates are scuff resistant materials. In some embodiments, impact plates are pliable materials that will not break on impact with the ground. In some embodiments, impact plates are materials that, when striking the ground or other hard surface, fracture to absorb energy from an impact. In some embodiments, energy absorbing unit 712 is a spring. In some embodiments, energy absorbing unit 712 is a pliable extruded polymer foam. In sonic embodiments, energy absorbing unit is a solid deformable material configured to soften impact when handle 706 strikes the ground, in some embodiments, impact plate 710 is excluded from the shock protection module and the energy absorbing unit 712 extends continuously across a face of the handle away from the luggage body.

FIG. 7B is an exploded view of AGV 740, showing further details of how the shock protection module 708 connects to handle grip 706A. Energy absorbing units 712 are fastened to handle 706A and to impact plate 710. When AGV 740 falls with handle side 704 toward the ground, impact plate 710 in the shock protection mechanism 708 will make direct contact with the ground, rather than handle grip 706A. Energy absorbing units 712 located between, and connected to, handle grip 706A and impact plate 710 absorbed some of the energy imparted to handle grip 706A upon striking the ground, dispersing the energy to prevent shock waves from traveling down handle arm 706B into AGV 740. Impact plate 710 also prevents handle grip 706A from being scratched or scuffed upon impact with the ground.

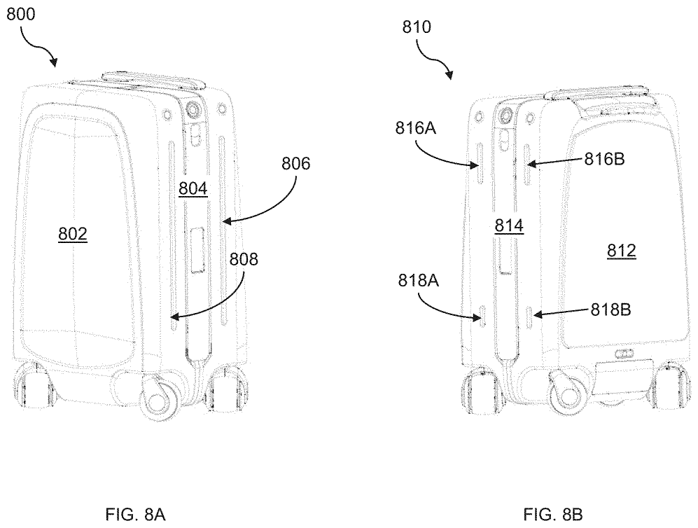

FIGS. 8A-B are diagrams of shock-protection modules integral to a luggage body, according to some embodiments. In FIG. 8A, AGV 800 includes luggage body 802 with shock protection modules 806 situated on lateral face 804 of the luggage body and extending along more than half of the lateral face length. Shock protection modules 806 are positioned to help prevent the lateral face 804 of the luggage body from impacting the ground during a fall. If the shock protection modules are too long, a risk of the shock protection module breaking during a fall increases. If the shock protection modules are too short or too close to the luggage body, a risk of the shock protection modules failing to prevent the luggage body from impacting the ground increases. In some embodiments, the length of the shock protection modules on a lateral face of the luggage body is approximately 75% of the height of the luggage body lateral side. In some embodiments, the luggage module has shock protection modules on a lateral face that are not less than ⅓ of the height of the luggage body lateral side. In some embodiments, shock protection modules are a spring-and-impact plate system fastened to lateral faces of the luggage body, as described previously for FIG. 7. In some embodiments, shock protection modules are made of a reversibly deformable porous materials fastened to lateral faces of the luggage body. In some embodiments, a luggage body lateral face has a single shock protection module. In some embodiments, a luggage body has three or more shock protection modules located on lateral faces thereof.

AGV 800 further includes, on an opening side 807 of the luggage body 802, least one shock protection module 808. In some embodiments, opening side shock protection modules are distributed vertically across the opening side 807. In some embodiments, shock protection modules 808 are concentrated at an upper end of the luggage body 802, away from the wheels, because the upper end is moves faster when striking the ground after a fall. In some embodiments, an AGV includes a single shock protection module at an upper end (e.g., at least 50% of the distance between the wheels and the top edge of the luggage body) of the opening side with no shock protection modules at the lower end of the opening side. In some embodiments, shock protection modules are made of a reversibly deformable porous materials fastened to lateral faces of the luggage body. In some embodiments, the shock protection modules are a spring-and-impact face

In FIG. 8B, AGV 810 has luggage body 812 with lateral face 814 and multiple shock protection modules thereon, and a handle side 817 with a plurality of shock protection modules 820 located thereon. Shock protection modules 816A-B are positioned at an upper end (e.g., farther from the wheels) of lateral face 814, while shock protection modules 818A-B are positioned at a lower end of lateral face 814. Shock protection modules 816A-B and 818A-B are different sizes, according to a predicted amount of force that is applied to a lateral face 814 when AGV 810 strikes the ground. Larger shock protection modules are desirable at an upper end of the lateral face because of the greater force of impact on the ground experienced by the upper end of lateral face 814, as compared to a lower end of lateral face 804. In some embodiments, upper shock protection modules 816A-B are the only shock protection modules on lateral face 814. Shock protection modules 820 on handle side 817 of the AGV are similar to shock protection modules on lateral faces and/or the opening side of the AGV. In some embodiments, shock protection modules 820 are further attached to an impact plate (not shown) that further protects luggage body 802

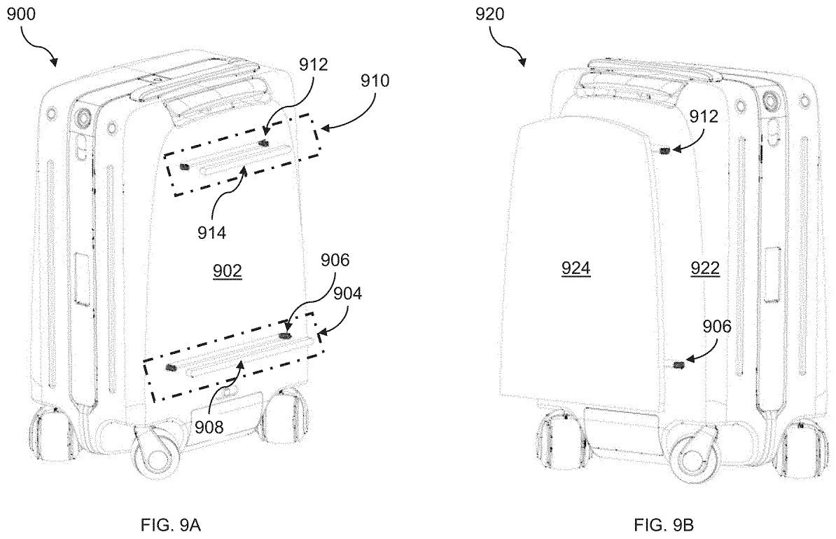

FIGS. 9A-B are diagrams of shock protection modules integral to a body of an AGV, according to some embodiments. In FIG. 9A, AGV 900 has a handle side 902 with two shock protection modules: lower shock protection module 904 with energy absorbing units 906 attached to impact plate 908, and upper shock protection module 910 with energy absorbing units 912 attached to impact plate 914. In some embodiments, lower shock protection module 904 is omitted from AGV 900. In some embodiments; the energy absorbing units are springs. In some embodiments; energy absorbing units are pliable extruded polymer foam. In some embodiments, energy absorbing units are solid deformable material configured to soften impact when an impact plate strikes the ground. In sonic embodiments, solid deformable material is configured to undergo irreversible physical deformation in order to absorb impact during a fall. Shock protection modules 904/910 are configured to extend across more than half of the handle side of the AGV 900. In some embodiments, multiple shock protection modules, having a width less than half the width of the handle side of the AGV, are disposed on the handle side near the corners, and/or toward the center, to protect interior components from impact-induced damage.

In FIG. 9B an AGV 920 has energy absorbing units 906 and 910 as described previously for FIG. 9A, but the impact plates 914 and 908 have been replaced by a single impact plate 924 on handle side 922. In sonic embodiments, single impact plate 924 fastens to each and all energy absorbing units on handle side 922. In some embodiments, half of the energy absorbing units at a level of handle face 922 upper level and lower level) are attached to impact plate, and half the energy absorbing units are attached to the handle face, but “float” free of impact plate 924.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A luggage protection system, comprising:
a luggage body having:
a bottom side,
a front face,
a handle face,
at least one lateral face sharing an edge with each of the bottom side, the front face, and the handle face;
a ground detection unit attached to the luggage body, wherein the ground detection unit is configured to determine whether the around adjacent to the luggage body is substantially level;
a drive system configured to propel the luggage body; and
a communication system, wherein the communication system is configured to transmit a warning signal in response to the ground detection unit determining the ground adjacent to the luggage body is not substantially level.

2. The luggage protection system of claim 1, wherein the ground detection unit comprises:
a ground signal emitter configured to emit a detection signal; and
a ground signal receive configured to receive a reflected signal based on the detection signal.

3. The luggage protection system of claim 1, wherein the communication system is further configured to transmit a drive system warning signal to a user.

4. The luggage protection system of claim 1, further comprising a warning signal receiving module configured to alert a user of the warning signal.

5. Luggage protection system of claim 1, further comprising a battery to provide electrical energy to the ground detection unit, the drive system, and the communication system.

6. The luggage protection system further comprising a guidance module integral to the luggage body.

7. The luggage protection system of claim 1, wherein the drive system comprises:
a drive control circuit; and
at least one motor, and wherein the bottom side of the luggage body further comprises at least one wheel connected to the at least one motor.

8. The luggage protection system of claim 7, wherein, in response to the transmission of the warning signal, the drive control circuit is configured to restrict operation of the at least one motor.

9. The luggage protection system of claim 2, wherein the transmitted ground signal emitter is configured to generate a laser signal.

10. The luggage protection system of claim 2, wherein the transmitted ground signal emitter is configured to generate an ultrasonic signal.

11. The luggage protection system of claim 1, wherein the ground detection unit comprises a mechanical component configured to contact with a ground surface.

12. A method of operating a luggage protection system, comprising
determining whether a ground surface adjacent to a luggage body is substantially level;
initiating movement of the luggage body in response to a determination that the ground surface adjacent to the luggage body is substantially level;
transmitting a warning signal in response to a determination that the ground surface adjacent to the luggage body is not substantially level; and
ceasing or preventing movement of the luggage body in response to the determination that the ground surface adjacent to the luggage body is not substantially level.

13. The method of claim 12, wherein the ceasing or preventing of the movement of the luggage body comprises ceasing movement of the luggage body.

14. The method of claim 12, wherein the initiating movement of the luggage body comprises controlling at least one motor connected to at least one wheel attached to the luggage body.

15. The method of claim 12, further comprising, probing, during movement of the luggage body, the presence of a rolling surface within a detection region of the luggage protection system.

16. An automated guided vehicle (AGV), comprising:
a luggage body having:
a bottom side,
a front face,
a back face,
a handle face,
at least one lateral face sharing an edge with each of the bottom side, the front face, and the handle face; and
a shock absorbing unit integral with at least one of the at least one lateral face, the back face or the handle face of the luggage body.

17. The AGV of claim 16, further comprising a second shock absorbing unit integral to the at least one lateral face.

18. The AGV of claim 17, wherein the shock absorbing unit comprises a compressible polymeric material.

19. The AGV of claim 17, wherein the shock absorbing unit comprises an impact plate and at least one spring connected to the impact plate and to an external surface of a luggage body.

20. The AGV of claim 17, wherein the shock absorbing unit is fastened to a distal end of a luggage handle.
